(19) United States
(12) Patent Application Publication
(10) Pub. No.: US 2010/0194983 A1
(43) Pub. Date: Aug. 5, 2010

(54) EQUIPMENT CONTROL APPARATUS

(75) Inventor: Takashi Iguchi, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/666,840

(22) PCT Filed: May 13, 2009
(86) PCT No.: PCT/JP2009/002091

§ 371 Date: Dec. 28, 2009

(30) Foreign Application Priority Data
May 14, 2008 (JP) 2008-126770

(51) Int. Cl. H04N 5/445; H04N 5/44

(52) U.S. Cl. 348/563; 348/734; 348/E05.103

(57) ABSTRACT

An equipment control apparatus capable of improving the command communication efficiency, wherein the equipment control apparatus (1) is provided with a receiver (11) for receiving an operation code transmitted from an operation device (3), and a processing unit (14). When the receiver (11) receives the operation code, the processing unit (14) determines whether or not the target source equipment (2) is compatible with the pass through control of the operation code, and upon determining that the source equipment (2) is incompatible, the processing unit (14) stops transmitting the command for transferring the operation code to the source equipment (2).

### TECHNICAL FIELD

The present invention relates to a device controlling apparatus. More particularly, the present invention relates to a device controlling apparatus to which a plurality of source devices are connected and which controls the connected source devices using commands.

### BACKGROUND ART

HDMI (High-Definition Multimedia Interface) is one of multimedia interfaces. With this HDMI, CEC (Consumer Electronics Control) is standardized. This CEC involves bus communication, and various commands are defined in CEC. CEC allows individual vendors to prepare a certain range of commands on their own, apart from commands defined according to the HDMI standard. Using such CEC commands, a device controlling apparatus (i.e. sink device) controls each of a plurality of source devices (for example, audio-visual devices) connected through HDMI cables (see, for example, Non-Patent Literature 1).

As described above, vendors of source devices can define their own commands. Therefore, there are cases where CEC-compliant source devices cannot interpret commands from connected sink devices. In view of the above background, methods for communicating vendor-specific commands between source devices and sink devices of different vendors have been proposed (see, for example, Patent Literature 1).

### Citation List

### Patent Literature

PTL 1: Japanese Patent Application Laid-Open No.2007-97095

### Non-Patent Literature

Non-PTL 1: High-Definition Multimedia Interface Specification Version 1.3a

### DISCLOSURE OF INVENTION

### Problems to be Solved by the Invention

Here, CEC is not an essential protocol of HDMI, and therefore there are cases where source devices are non-CEC-compliant. Further, there are cases where vendor-specific CEC commands are implemented in sink devices and source devices. In view of above, there are cases where sink devices cannot control source devices because the source devices do not make responses when receiving CEC commands.

Further, the transmission rate of CEC is low at 400 bps, and therefore communication between devices that cannot be controlled by CEC commands interferes with communication between other connected devices and deteriorates communication efficiency.

It is therefore an object of the present invention to provide a device controlling apparatus that can improve the communication efficiency of CEC commands.

### Solution to Problem

To achieve the above object, an aspect of the present invention that is a device controlling apparatus has: a receiver that receives an operation code transmitted from an operator; a decision processing section that, after the receiver receives the operation code, decides whether or not a target source device complies with pass-through control based on the operation code; and a stopping processing section that, after the decision processing section decides that the source device does not comply with the pass-through control based on the operation code, stops transmitting a command for forwarding the operation code, to the source device.

### Advantageous Effects of Invention

When the source device that does not comply with pass-through control is found, the above device controlling apparatus stops transmitting CEC commands to this source device to prevent CEC commands from being transmitted unnecessarily, and improves the communication efficiency of CEC commands.

### BRIEF DESCRIPTION OF DRAWINGS

FIG. 1 is a block diagram showing a configuration of a device controlling apparatus 1 according to an embodiment of the present invention;

FIG. 2 is a flowchart showing processing in the device controlling apparatus 1 when a source device 2 is connected;

FIG. 3 shows a message M₁ that is displayed on a display 13 shown in FIG. 1;

FIG. 4 is a sequence chart showing exchange of CEC commands in the CEC compliance/non-compliance check process;

FIG. 5 is a flowchart showing the processing in the device controlling apparatus 1 after an operator (i.e. remote controller) 3 is operated;

FIG. 6 is a sequence chart showing the first half of exchange of CEC commands in the CEC remote controller pass-through control compliance/non-compliance check process;

FIG. 7 is a sequence chart showing the second half of exchange of CEC commands in the CEC remote controller pass-through control compliance/non-compliance check process;

FIG. 8 is a flowchart showing an alternative example of the processing in the device controlling apparatus 1 after the operator (i.e. remote controller) 3 is operated; and

FIG. 9 shows an alternative example of the message M₁ that is displayed on the display 13 shown in FIG. 1.

### DESCRIPTION OF EMBODIMENTS

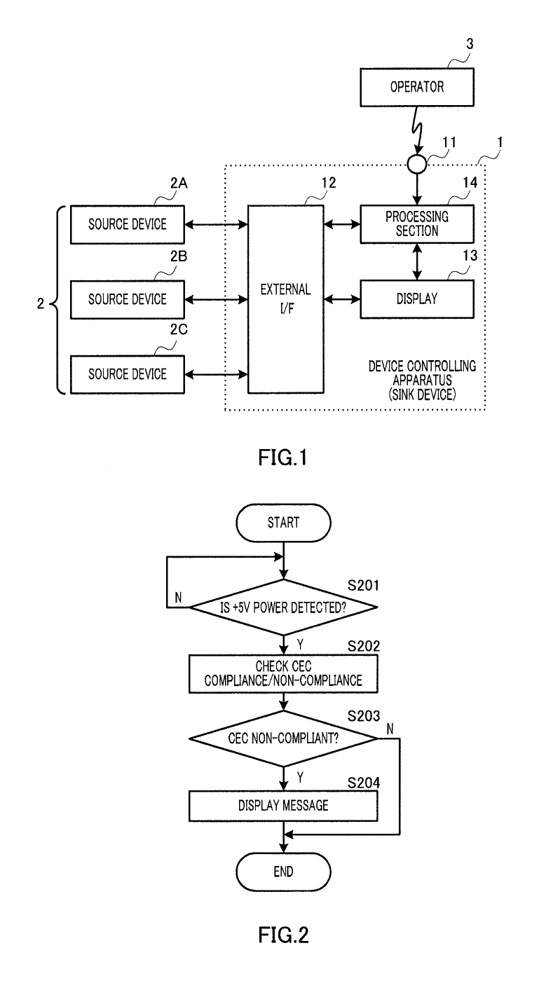

FIG. 1 is a block diagram showing the configuration of a device controlling apparatus (i.e. sink device) 1 according to an embodiment of the present invention. Further, FIG. 1 shows at least one source device 2 (in this figure, sources 2A to 2C are shown) and an operator 3, as peripheral equipment of the device controlling apparatus 1. The source device 2 and the operator 3 will be explained below before the device controlling apparatus 1 will be explained in detail.

Each source device 2 enables HDMI (High-Definition Multimedia Interface) output and is, for example, a digital movie camera. Each source device 2 is connected with the device controlling apparatus 1 through an HDMI cable, and sends video signals to the device controlling apparatus 1 through this HDMI cable.

With the present embodiment, the operator 3 is a remote controller that allows the user remotely control each source device 2 through the device controlling apparatus 1, and has, for example, buttons to which various kinds of functions are assigned. When the user operates a button, the operator 3 generates the operation code assigned to the button that is operated, modulates an infrared signal by the generated operation code and then outputs the signal to the device controlling apparatus 1.

Next, the device controlling apparatus 1 will be explained. The device controlling apparatus 1 has a receiver 11, an external interface (I/F) 12, a display 13 and a processing section 14.

The receiver 11 receives as input light of the infrared signal outputted from the operator 3, demodulates the received infrared signal and, by this means, acquires the operation code. The acquired operation code is sent to the processing section 14.

The external I/F 12 has a plurality of HDMI ports, and each port can be connected with one source device 2. The external I/F 12 receives as input video signals sent from the source device 2 connected to each port. The external I/F 12 selects at least one of the input video signals, and outputs this signal to the display 13. Further, the external I/F 12 selects the video signal that must be outputted to the display 13, according to the setting from the processing section 14.

Additionally, the external I/F 12 receives CEC commands sent from the processing section 14 as control commands, sends the video signal to the source device 2 that is outputting signals, and sends the CEC commands sent from the source device 2 that is outputting video signals, to the processing section 14.

The display 13 displays an image according to the video signal from the external I/F 12. Additionally, the display 13 displays messages according to message signals from the processing section 14.

The processing section 14 controls each section forming the device controlling apparatus 1. Additionally, the processing section 14 controls the transmission of CEC commands.

Next, processing in the device controlling apparatus 1 will be explained first with reference to FIG. 2. FIG. 2 is a flowchart showing processing in the device controlling apparatus 1 when the source device 2 is connected.

In FIG. 2, the processing section 14 decides whether or not the source device 2 is connected to any of the ports of the external I/F 12 (step S201). Detecting +5V power of an HDMI connector is one specific method of making decisions in step S201. To be more specific, when the source device 2 is connected to a port of the external I/F 12, the source device 2 that is connected supplies +5V power to the device controlling apparatus 1. If +5V power is supplied to the port, the processing section 14 decides on “Yes” in step S201, the flow proceeds to step S202. If +5V power is not supplied, the processing section 14 returns to step S201, and waits until the source device 2 is connected.

When the processing section 14 decides on “Yes” in step S201, the processing section 14 performs the CEC compliance/non-compliance check process (step S202). The processing section 14 makes decisions in step S202, using a CEC command <Report Physical Address> sent immediately after a CEC-compliant device is connected.

To be more specific, when the source device 2 is connected to a port of the external I/F 12, the source device 2 acquires the physical address set in the port. Then, the connected source device 2 starts the processing for acquiring a logical address, and sends <Report Physical Address> for broadcasting the acquired physical address. Following the connection detection in step S201, if the processing section 14 can acquire <Report Physical Address> matching the physical address of the connected port, from the connected source device 2 within a certain period set in advance, the processing section 14 decides that the connected source device 2 is CEC-compliant.

By contrast with this, if the processing section 14 cannot acquire <Report Physical Address> matching the physical address of the connected port, from the connected source device 2 within a certain period, the processing section 14 decides that the connected source device 2 is non-CEC-compliant.

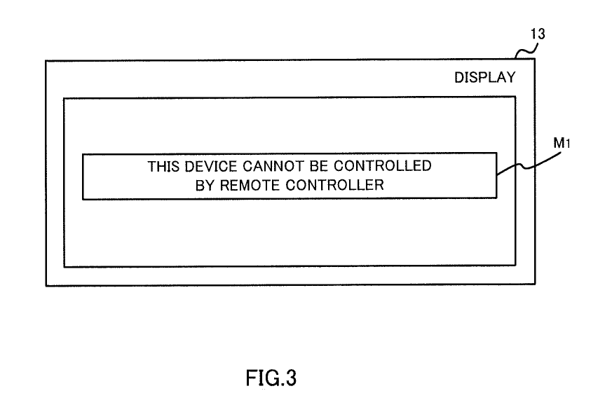

Based on the result of the above processings, the processing section 14 decides whether or not the connected source device 2 is CEC-compliant (step S203). When deciding on “Yes,” the processing section 14 generates a message signal for notifying the user that the connected source device 2 is non-CEC-compliant, and sends the signal to the display 13. When receiving the message signal, the display 13 displays its content M₁ for a certain period, as shown in FIG. 3, to notify the user that the connected source device 2 is non-CEC-compliant (step S204). When step S204 is finished, the processing section 14 finishes the processing of FIG. 2.

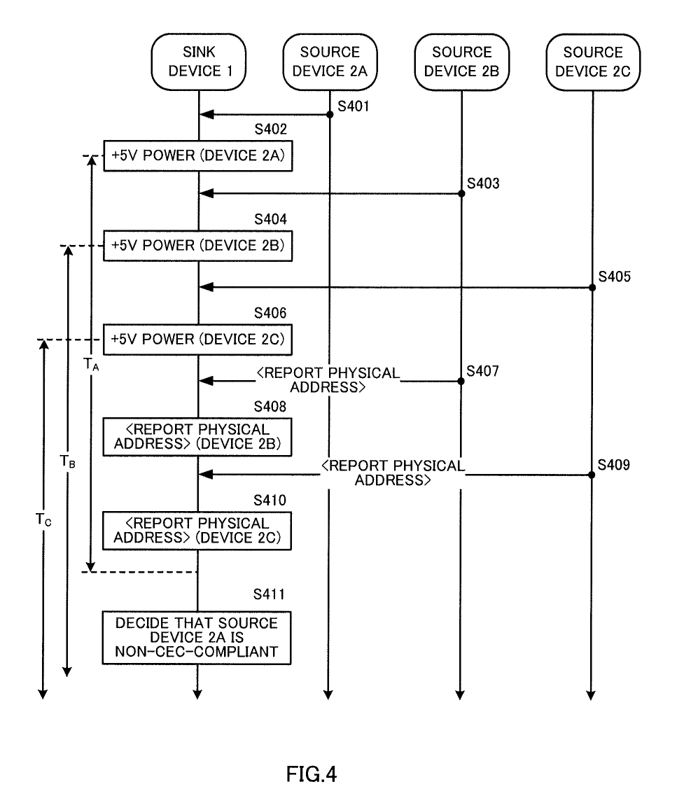

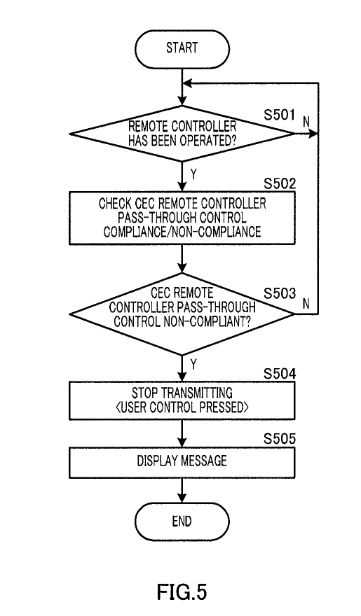

Next, a specific example of the CEC compliance/non-compliance check process in step S202, will be explained with reference to FIG. 4. FIG. 4 is a sequence chart showing exchange of CEC commands between the device controlling apparatus 1 and the source devices 2A to 2C in the CEC compliance/non-compliance check process.

With the example of FIG. 4, the CEC compliance/non-compliance check process is performed with respect to the source devices 2A to 2C at substantially the same time. Here, assume that the source device 2A alone is non-compliant. When the source devices 2A to 2C are connected to ports of the external I/F 12, the source devices 2A to 2C each supply +5V power to the device controlling apparatus 1 (S401, S403 and S405 in the sequence).

In the device controlling apparatus 1, the processing section 14 starts the timer (not shown) of each port at the time +5V power from each of the source devices 2A to 2C is detected (S402, S404 and S406 in the sequence), and starts measuring predetermined periods T_{A}, T_{B} and T_{C}. When connection is established with the HDMI after +5V power is supplied, the CEC-compliant devices of the source device 2A to 2C send <Report Physical Addresses>, to the device controlling apparatus 1 (S407 and S409 in the sequence). As is clear from above, the source devices 2B and 2C are CEC-compliant, and, in the example of FIG. 4, send <Report Physical Addresses>.

If <Report Physical Addresses> are received before the predetermined periods T_{A}, T_{B} and T_{C} expire, the processing section 14 stops the measurement by the timers of the corresponding ports, and recognizes that the CEC-compliant devices are connected to the corresponding ports.

By contrast with this, if <Report Physical Addresses> cannot be received before the predetermined periods T_{A}, T_{B} and T_{C} expire, the processing section 14 recognizes that the non-CEC-compliant device is connected to the corresponding port.

This concludes the CEC compliance/non-compliance check process. With the example of FIG. 4, the source device 2A is non-CEC-compliant and does not send <Report Physical Address> within the predetermined period T_{A}, and therefore the processing section 14 decides that the source device 2A is non-CEC-compliant at the time the predetermined time T_{A} passes.

Further, the CEC compliance/non-compliance check process is performed per port of the external I/F 12. With the example of FIG. 4, although the CEC compliance/non-compliance check process is performed with respect to all source devices 2A to 2C at substantially the same time, there are cases where the CEC compliance/non-compliance check process is performed separately with respect to the source devices 2A to 2C.

When the processing of FIG. 2 explained above is finished, the user operates the operator 3 such that the processing section 14 sets up the external I/F 12 to output video signals from at least one source device 2, to the display 13. By this means, the display 13 receives the video signal from the set source device 2 through the external I/F 12, and displays an image according to the received video signal.

The processing for remotely controlling the source device 2 that is outputting a video signal (hereinafter, referred to as “target source device”) by the operator 3, will be explained with reference to FIG. 5. FIG. 5 is a flowchart showing the processing in the device controlling apparatus 1 after the operator 3 is operated. In FIG. 5, the processing section 14 decides whether or not the operator 3 has been operated (step S501). To be more specific, if an operation code has not been received from the receiver 11, the processing section 14 decides on “No” in step S501, returns to step S501 and waits until the operation code is received.

By contrast with this, if the operation code has been received from the receiver 11, the processing section 14 decides on “Yes” in step S501. After making decisions as described above, the processing section 14 sends the CEC command <User Control Pressed> matching the operation code, to the target source device 2 through the external I/F 12. Here, <User Control Pressed> is used to forward from the device controlling apparatus 1 of the sink device to the target source device 2, the operation code sent from the operator 3.

According to the HDMI standard, if processing of the received CEC command is not executable, the target source device 2 returns the command <Feature Abort> to the device controlling apparatus 1. The parameters of <Feature Abort> include [Feature Opcode], and, if <User Control Pressed> is not supported, Opcode of <User Control Pressed> is set as the value of [Feature Opcode]. Here, <Feature Abort> is used as a response to show whether the target source device 2 supports or cannot execute the requested CEC command at the moment.

The processing section 14 receives <Feature Abort> through the external I/F 12, and can confirm whether or not the target source device 2 supports <User Control Pressed>, based on information of <Feature Abort>. Using the processing of this <Feature Abort>, the processing section 14 performs the process of checking whether or not the target source device 2 complies with CEC remote controller pass-through control (step S502). Based on the result of this check process, the processing section 14 decides whether or not the target source device 2 complies with CEC remote controller pass-through control (step S503).

For more detailed explanation of processings in steps S502 and 503, the processing section 14 counts the number of times <Feature Abort> is received, in response to <User Control Pressed> sent to the target source device 2. The processing section 14 decides that the target source device 2 having received <Feature Abort> a predetermined number of times, as the device that does not comply with CEC remote controller pass-through control, that is, decides on “Yes” in step S503.

When deciding on “No” in step S503, the processing section 14 returns to step S501 and waits until the remote controller is operated again. By contrast with this, when deciding on “Yes” in step S503, first, the processing section 14 stops transmitting <User Control Pressed> to this target source device 2 that does not comply with CEC remote controller pass-through control, in response to subsequent operation codes.

Following step S504, the processing section 14 generates a message signal for notifying the user that the target source device 2 is non-CEC-compliant, and sends the signal to the display 13. When receiving the message signal, the display 13 shows its content M₁ for a certain period, as shown in FIG. 3, and notifies the user that the target source device 2 is non-CEC-compliant (step S505). By this means, it is possible to remind of the user not to repeat operating the operator 3 in the same way. Further, in this case, the user operates the source device 2 or its attachment of a remote controller.

Further, although not shown in FIG. 5, when the external I/F 12 and the target source device 2 are disconnected, the processing of FIG. 5 is finished then.

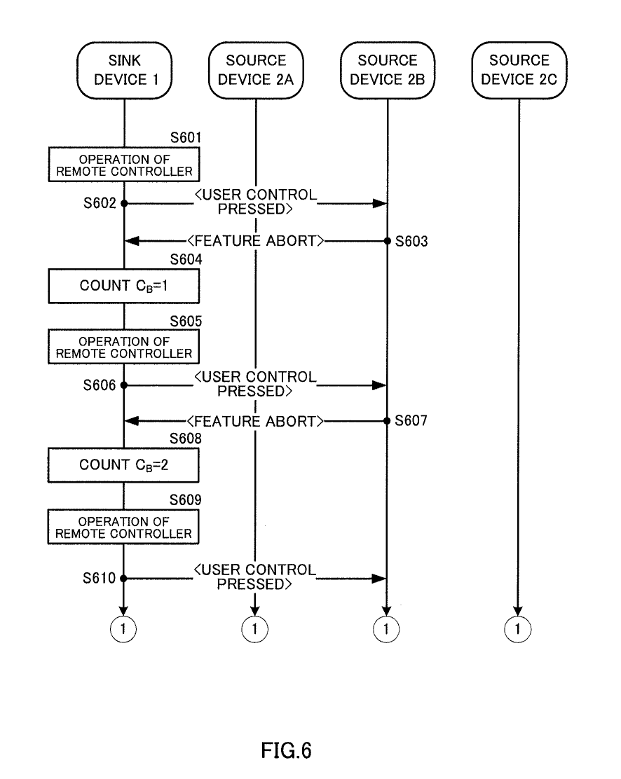

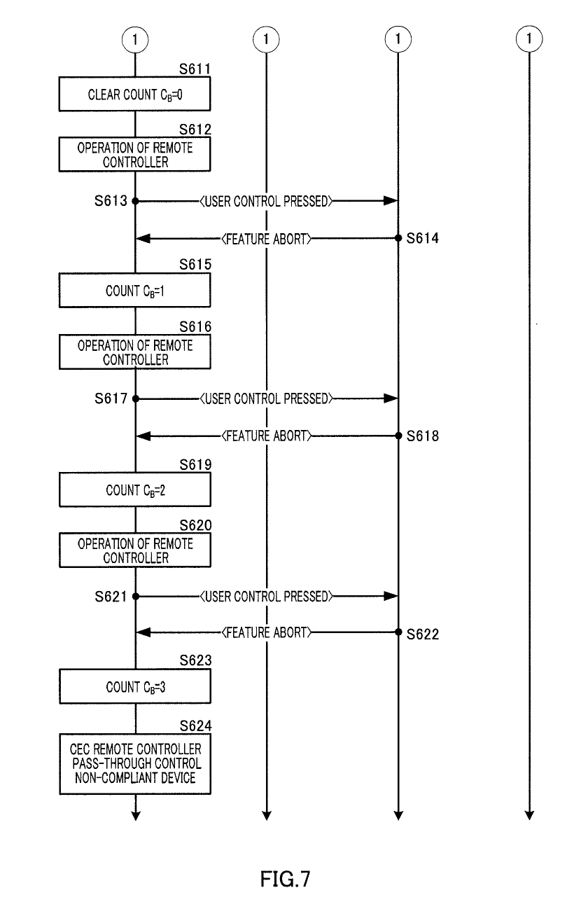

Next, a specific example of the process of checking CEC remote controller pass-through control compliance/non-compliance in step S502, will be explained with reference to FIG. 6 and FIG. 7. FIG. 6 and FIG. 7 show the first half and the second half of a sequence chart of exchange of CEC commands between the device controlling apparatus 1 and the target source device 2 in the CEC remote controller pass-through control compliance/non-compliance check process.

Further, FIG. 6 and FIG. 7 show cases where the target source device 2 is the source device 2B. Furthermore, although, in FIG. 6 and FIG. 7, the remote controller is illustrated to be operated a plurality of times in the CEC remote controller pass-through control compliance/non-compliance check process for ease of explanation, the actual processing undergoes the processing of step S502 every time the remote controller is operated, and moves onto the processing of step S501 to wait for the remote controller to be operated.

First, in FIG. 6, when receiving an operation code from the operator 3 through the receiver 11 (S601 in the sequence), the processing section 14 converts the received operation code into a CEC command, and sends <User Control Pressed> to the target source device 2B through the external I/F 12 (S602 in the sequence).

The processing section 14 has a counter (not shown) for the process of checking whether or not the target source device 2B complies with CEC remote controller pass-through control, and this value on the counter is incremented (S604 in the sequence) every time <Feature Abort> is received from the target source device 2B in response to <User Control Pressed> (S603 in the sequence).

By contrast with this, if <Feature Abort> is not received in response to <User Control Pressed>, the counter value is reset (S611 in the sequence of FIG. 7).

These series of operations are repeated every time an operation code is received (S605 in the sequence of FIG. 6 to S623 in the sequence of FIG. 7).

When the counter value exceeds the value that is set in advance (hereinafter, referred to as “reference value”), the processing section 14 decides that the target source device 2B does not comply with CEC remote controller pass-through control (S624 in the sequence). Further, with the example of FIG. 7, the reference value is set to C_{B}=3.

In the parameters of <User Control Pressed>, one [UI Command] is prepared for one operation code from the operator 3. Although the reference value of the counter value is not set per operation code type with the examples of FIG. 6 and FIG. 7, a method of preparing a counter per operation code type (per parameter of [UI Command]) and performing the CEC remote control pass-through control compliance/non-compliance check process (step S502) per operation code type, is possible.

In the above-described case where the source device 2 is controlled by the CEC commands, the device controlling apparatus 1 has the functions for checking the situation of responses from the source device 2 and deciding whether or the source device 2 is CEC compliant and does not execute CEC commands. When the source device 2 that cannot be controlled by the CEC commands is found thanks to this function, it is possible to notify the user that the source device 2 cannot be controlled by the CEC commands, and furthermore stop transmitting the CEC commands to the source device 2 to prevent the CEC commands from being transmitted unnecessarily, and improve the communication efficiency of CEC commands.

Further, although, with the above explanation, the device controlling apparatus 1 receives an operation code from a remote controller which is illustrated as the operator 3, it is equally possible to receive operation codes from a touch panel or keyboard mounted on the device controlling apparatus 1.

Furthermore, although, with the above explanation, the three source devices 2 are connected to the device controlling apparatus 1, the number of source devices 2 to connect may be other than three.

Still further, with the above explanation, if the CEC command <Report Physical Address> is not received in a certain period in the CEC compliance/non-compliance check process (step S202 of FIG. 2), the processing section 14 decides that the source device 2 is non-CEC-compliant. However, the present invention is not limited to this, and, if the CEC command <Report Physical Address> is not received in a certain period, the processing section 14 may transmit the CEC command <Give Physical Address> at least one more time to the source device 2 to check again whether or not the source device 2 complies with CEC. <Give Physical Address> is used to return the physical address of the source device 2. Further, the CEC command for performing a check again is not limited to <Give Physical Address>, and may be a CEC command that is defined according to the HDMI standard and that makes responses mandatory.

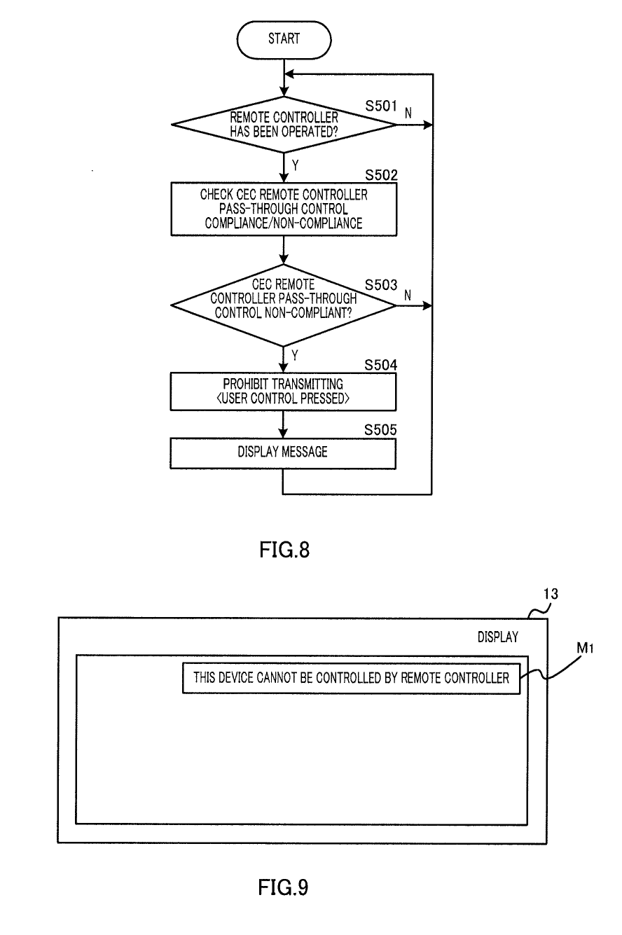

Further, with the above explanation, when the processing section 14 decides that the source device 2 does not comply with CEC remote controller pass-through control, the processing of FIG. 5 is finished. However, the present invention is not limited to this, and, even if the source device 2 complies with CEC remote controller pass-through control, cases may be assumed depending on the time decisions are made in the processing section 14, where <Feature Abort> is returned in response to <User Control Pressed> due to some factors. Assuming these cases, a method of finishing the processing of step S505 and then returning processing to step S501 after a certain period, may be adopted as shown in FIG. 8.

Further, with the above explanation, the counter is provided to count the number of times <Feature Abort> is received in the CEC remote controller pass-through control compliance/non-compliance check process (step S502 in FIG. 5). However, the present invention is not limited to this, and each content of [Abort Reason] included as a parameter of <Feature Abort> may be counted. In addition, counters for the process of checking the CEC remote controller pass-through control compliance/non-compliance, may count the number of times ACK bit is not detected in response to <User Control Pressed>.

Further, with the above explanation, when the source device 2 either does not comply with CEC or does not comply with CEC remote controller pass-through control, the message M₁ shown in FIG. 3 is displayed on the display 13 as a method of providing notices to users. However, the present invention is not limited to this, and messages may vary between the non-CEC-compliant device and the device that does not comply with CEC remote controller pass-through control, or different display methods may be employed.

Further, with the above explanation, the message M₁ shown in FIG. 3 is displayed for a certain period after the CEC compliance/non-compliance check process (step S202 of FIG. 2) or the CEC remote controller pass-through control compliance/non-compliance check process (step S502 of FIG. 5). However, the present invention is not limited to this, and, after the message M₁ is displayed once, the message M₁ may be immediately displayed for a certain period every time the operator 3 receives the same operation. Further, the message M₁ may be displayed in, for example, the corner of the screen of the display 13 as shown in FIG. 9 so as not to prevent images from being displayed.

Furthermore, although, with the above explanation, notices to the user are provided by displaying the message M₁ on the display 13, it is equally possible to provide notices to the user by a buzzer sound, speech guidance and so on.

The disclosure of Japanese Patent Application No. 2008-126770, filed on May 14, 2008, including the specification, drawings and abstract, is incorporated herein by reference in its entirety.

### INDUSTRIAL APPLICABILITY

The device controlling apparatus according to the present invention provides an advantage of improving the communication efficiency of CEC commands, and is useful in, for example, display apparatuses that can serve as sink apparatuses.

### REFERENCE SIGNS LIST

1. DEVICE CONTROLLING APPARATUS (SINK DEVICE)

11 RECEIVER

12 EXTERNAL I/F

13 DISPLAY

14 PROCESSING SECTION

2 SOURCE DEVICE

3 OPERATOR (REMOTE CONTROLLER)

1. A device controlling apparatus comprising:
a receiver that receives an operation code transmitted from an operator;
a decision processing section that, after the receiver receives the operation code, decides whether or not a target source device complies with pass-through control based on the operation code; and
a stopping processing section that, after the decision processing section decides that the source device does not comply with the pass-through control based on the operation code, stops transmitting a command for forwarding the operation code, to the source device.

2. The device controlling apparatus according to claim 1, further comprising an external interface that, after the receiver receives the operation code, transmits the command to the source device and receives a response indicating that the command cannot be executed, from the source device,
wherein, after the external interface receives the response a predetermined number of times or more, the decision processing section decides that the source device does not comply with the pass-through control based on the operation code.

3. The device controlling apparatus according to claim 1, further comprising a display that, after the decision processing section decides that the source device does not comply with the pass-through control based on the operation code, displays a message notifying that the source device does not comply with the pass-through control.
